(19) United States
(12) Patent Application Publication
(10) Pub. No.: US 2026/0331831 A1
(43) Pub. Date: Oct. 22, 2026

(54) INPUT/OUTPUT CONNECTOR FOR REDUCED IMPEDANCE AND CROSSTALK

(71) Applicant: Molex, LLC, Lisle, IL (US)

(72) Inventors: Suraj Sridhar, Naperville, IL (US); Dominic Steier, Naperville, IL (US)

(21) Appl. No.: 19/445,687

(22) Filed: Jan. 12, 2026

Related U.S. Application Data
(60) Provisional application No. 63/749,715, filed on Jan. 27, 2025.

(51) Int. Cl. H01R 13/6581; H01R 12/72; H01R 13/6596; H01R 13/6597

(52) U.S. Cl. CPC H01R 13/6581; H01R 12/724; H01R 12/725; H01R 12/727; H01R 13/6596; H01R 13/6597

(57) ABSTRACT

Connector designs for reduced impedance and crosstalk, improved alignment and structural integrity, and other benefits are described herein. An example connector includes a first wafer assembly and a second wafer assembly. The first wafer assembly includes a first wafer body, a first row of terminals, and a first locking projection extending downward. The second wafer assembly includes a second wafer body, a second row of terminals, and a second locking projection extending upward. The first locking projection and the second locking projection are sized and positioned to couple to one another and form an interference connection. The locking projections can help to align the wafer assemblies and the rows of terminals with respect to each other, maintain better positional tolerance in the connector, and achieve other benefits.

### TECHNICAL FIELD

The present disclosure generally relates to electrical connectors for high-speed data transmission and, in particular, to input/output connector systems with shielding and retention features for high-speed data transmission in datacenter and like applications.

### BACKGROUND

High-speed data transmission in modern computing environments, such as data centers, requires connectors capable of handling increasingly higher data rates while maintaining signal integrity. As data rates continue to increase, traditional connector designs struggle to meet performance requirements due to issues such as crosstalk, impedance mismatches, and electromagnetic interference. These challenges can lead to signal degradation, increased bit error rates, and reduced overall system performance.

Connector designers have implemented various strategies to address these issues, including the use of shielding, impedance matching techniques, and advanced materials. However, as data rates push into the multi-gigabit per second range and beyond, there is an ongoing need for innovative connector designs that can provide improved signal integrity, reduced crosstalk, and consistent impedance characteristics. Additionally, these high-performance connectors must maintain reliability and ease of use in datacenter environments where frequent connections and disconnections may occur.

### BRIEF SUMMARY

According to an aspect of the present disclosure, a data connector is provided. The data connector includes a first wafer assembly positioned in a housing of the data connector, the first wafer assembly comprising a first wafer body supporting a first row of terminals, the first wafer body comprising a first locking projection extending downward. The data connector also includes a second wafer assembly positioned in the housing of the data connector, the second wafer assembly comprising a second wafer body supporting a second row of terminals, the second wafer body comprising a second locking projection extending upward, where the first locking projection and the second locking projection are sized and positioned to couple to one another and form an interference connection. The data connector further includes a conductive shield positioned towards connection ends of at least one of the first row of terminals and the second row of terminals, the conductive shield being formed of a flexible material that permits terminal deflection.

The conductive shield may be a first conductive shield covering a first portion of the first row of terminals, and the data connector may further include a second conductive shield covering a second portion of the first row of terminals, with a third portion of the first row of terminals not covered by the first conductive shield or the second conductive shield. The data connector may further include a third conductive shield covering a first portion of the second row of terminals and a fourth conductive shield covering a second portion of the second row of terminals, with a third portion of the second row of terminals not covered by the third conductive shield or the fourth conductive shield. The first, second, third, and fourth conductive shields may be welded to respective terminals in the first row of terminals and the second row of terminals. The first row of terminals and the second row of terminals may each include terminals having an aperture positioned therein, where ends of the first, second, third, and fourth conductive shields are crimped through a respective terminal aperture of the first row of terminals and the second row of terminals. The terminals having the aperture positioned therein may be ground terminals.

The data connector may further include a first rigid ground shield positioned below and coupled to the first row of terminals, the first rigid ground shield extending substantially along a length of the first row of terminals. The data connector may also include a second rigid ground shield positioned above and coupled to the second row of terminals, the second rigid ground shield extending substantially along a length of the second row of terminals. The data connector may be a right-angle connector, and the first rigid ground shield and the second rigid ground shield may each include a plurality of notched-out regions that facilitate a right-angle bend of the first rigid ground shield and the second rigid ground shield. The first rigid ground shield and the second rigid ground shield may each include a plurality of channels formed integral with one another, the first rigid ground shield and the second rigid ground shield each being formed from a single piece of conductive material, a subset of terminals of the first row of terminals and the second row of terminals being situated in the plurality of channels.

The first rigid ground shield may include a first gap positioned between two portions of the first rigid ground shield, where the first locking projection is positioned in the first gap, and the second rigid ground shield may include a second gap positioned between two portions of the second rigid ground shield, where the second locking projection is positioned in the second gap. The first rigid ground shield and the second rigid ground shield may be secured to bodies of the first wafer assembly and the second wafer assembly, respectively, using rivets. The rivets can include injection molded rivets.

The data connector may be a right-angle connector, the first row of terminals having a first right-angle bend, and the second row of terminals having a second right-angle bend, the connection ends of the first row of terminals and the second row of terminals being positioned in a front opening of a body of the data connector, and mounting ends of the first row of terminals and the second row of terminals being positioned in a bottom opening of the body of the data connector for coupling to a substrate. A subset of terminals of the first row of terminals and the second row of terminals may be arranged in terminal pairs for differential signaling. The conductive shield may be formed of a conductive metal material.

The first locking projection and the second locking project may each include vertical members offset from one another and horizontal members extending from the vertical members, each forming an L-shaped or J-shaped hook. The first locking projection and the second locking projection may be symmetrical. Upper surfaces of the horizontal members may include a step that separates two planar surfaces offset from one another, a first one of the two surfaces sloping downward from a rear end to a front end of a respective horizontal member, an upper surface of the step contacting a surface of an opposite wafer body. The first locking projection and the second locking projection hook may be aligned approximately in a middle of the data connector, and the first locking projection may be a first L-shaped or J-shaped hook projection and the second locking projection may be a second L-shaped or J-shaped hook projection.

According to another aspect of the present disclosure, a data connector is provided. The data connector includes a first wafer assembly positioned in a housing of the data connector, the first wafer assembly comprising a first wafer body supporting a first row of terminals, the first wafer body comprising a first locking projection extending downward. The data connector also includes a second wafer assembly positioned in the housing of the data connector, the second wafer assembly comprising a second wafer body supporting a second row of terminals, the second wafer body comprising a second locking projection extending upward, where the first locking projection and the second locking projection are sized and positioned to couple to one another and form an interference connection. The data connector further includes a first rigid ground shield positioned below and coupled to the first row of terminals, the first rigid ground shield extending substantially along a length of the first row of terminals, and a second rigid ground shield positioned above and coupled to the second row of terminals, the second rigid ground shield extending substantially along a length of the second row of terminals.

The data connector may be a right-angle connector, and the first rigid ground shield and the second rigid ground shield may each include a plurality of notched-out regions that facilitate a right-angle bend of the first rigid ground shield and the second rigid ground shield. The first rigid ground shield and the second rigid ground shield may each include a plurality of channels formed integral with one another, the first rigid ground shield and the second rigid ground shield each being formed from a single piece of conductive material, a subset of terminals of the first row of terminals and the second row of terminals being situated in the plurality of channels. The first rigid ground shield may include a first gap positioned between two portions of the first rigid ground shield, where the first locking projection is positioned in the first gap, and the second rigid ground shield may include a second gap positioned between two portions of the second rigid ground shield, where the second locking projection is positioned in the second gap. The first rigid ground shield and the second rigid ground shield can be secured to the first wafer assembly and the second wafer assembly, respectively, using injection molded rivets.

The data connector may further include a conductive shield positioned towards connection ends of at least one of the first row of terminals and the second row of terminals, the conductive shield being formed of a flexible material that permits terminal deflection. The conductive shield may be a first conductive shield covering a first portion of the first row of terminals, and the data connector may further include a second conductive shield covering a second portion of the first row of terminals, with a third portion of the first row of terminals not covered by the first conductive shield or the second conductive shield. The data connector may further include a third conductive shield covering a first portion of the second row of terminals and a fourth conductive shield covering a second portion of the second row of terminals, with a third portion of the second row of terminals not covered by the third conductive shield or the fourth conductive shield. The first, second, third, and fourth conductive shields may be welded to respective terminals in the first row of terminals and the second row of terminals.

The first row of terminals and the second row of terminals may each include terminals having an aperture positioned therein, where ends of the first, second, third, and fourth conductive shields are crimped through a respective terminal aperture of the first row of terminals and the second row of terminals. The terminals having the aperture positioned therein may be ground terminals. The data connector may be a right-angle connector, the first row of terminals having a first right-angle bend, and the second row of terminals having a second right-angle bend, the connection ends of the first row of terminals and the second row of terminals being positioned in a front opening of a body of the data connector, and mounting ends of the first row of terminals and the second row of terminals being positioned in a bottom opening of the body of the data connector for coupling to a substrate. A subset of terminals of the first row of terminals and the second row of terminals may be arranged in terminal pairs for differential signaling. The conductive shield may be formed of a conductive metal material.

The first locking projection and the second locking project may each include vertical members offset from one another and horizontal members extending from the vertical members, each forming an L-shaped or J-shaped hook. The first locking projection and the second locking projection may be symmetrical. Upper surfaces of the horizontal members may include a step that separates two planar surfaces offset from one another, a first one of the two surfaces sloping downward from a rear end to a front end of a respective horizontal member, an upper surface of the step contacting a surface of an opposite wafer body. The first locking projection and the second locking projection hook may be aligned approximately in a middle of the data connector, and the first locking projection may be a first L-shaped or J-shaped hook projection and the second locking projection may be a second L-shaped or J-shaped hook projection.

Another example connector includes a first wafer assembly having a first wafer body, a first row of terminals, and a first locking projection extending downward and a second wafer assembly having a second wafer body, a second row of terminals, and a second locking projection extending upward. The first locking projection and the second locking projection are sized and positioned to couple to one another and form an interference connection.

In other aspects, the first locking projection can be formed along an edge of a first projection plate, the second locking projection can be formed along an edge of a second projection plate, and the first and second projection plates are formed of a conductive material. The first wafer assembly also includes a first ground shield in some cases, and the first projection plate can be electrically coupled to the first ground shield. The second wafer assembly also includes a second ground shield in some cases, and the second projection plate can be electrically coupled to the second ground shield. In still other aspects, the first locking projection includes a first L-shaped or J-shaped hook projection, and the second locking projection includes a second L-shaped or J-shaped hook projection. The first L-shaped or J-shaped hook projection can be electrically coupled with the second L-shaped or J-shaped hook projection.

This summary is provided to introduce a selection of concepts in a simplified form that are further described below in the detailed description, and is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a connector according to various embodiments of the present disclosure.

FIG. 2 is a bottom perspective view of the connector according to various embodiments of the present disclosure.

FIG. 3 is a front elevation view of the connector according to various embodiments of the present disclosure.

FIG. 4 is a rear elevation view of the connector according to various embodiments of the present disclosure.

FIG. 5 is a bottom view of the connector according to various embodiments of the present disclosure.

FIG. 6 is a top perspective view of two wafer assembly bodies of the connector retaining two terminal rows according to various embodiments of the present disclosure.

FIG. 7 is a top perspective view of two wafer assembly bodies of the connector with a housing and the terminal rows omitted according to various embodiments of the present disclosure.

FIG. 8 is an enlarged view of a coupling of interlocking components of the wafer assemblies according to various embodiments of the present disclosure.

FIG. 9 is a top perspective view of a wafer assembly retaining terminals therein according to various embodiments of the present disclosure.

FIG. 10 is a side cross-section view of the connector according to various embodiments of the present disclosure.

FIG. 11 is a bottom perspective view of a representative wafer assembly retaining terminals therein according to various embodiments of the present disclosure.

FIG. 12 is a bottom perspective view of the connector according to various embodiments of the present disclosure.

FIG. 13 is a top perspective partially-transparent view of the connector as mounted on a substrate according to various embodiments of the present disclosure.

FIG. 14 is another side cross-section view of the connector according to various embodiments of the present disclosure.

FIGS. 15A-15C are different positions of the wafer assemblies relative to a housing of the connector according to various embodiments of the present disclosure.

FIG. 16A is a perspective view of other example wafer assemblies of the connector according to various embodiments of the present disclosure.

FIG. 16B is a first perspective view of the wafer assemblies shown in FIG. 16A, exploded apart from each other, according to various embodiments of the present disclosure.

FIG. 16C is a second perspective view of the wafer assemblies shown in FIG. 16A, exploded apart from each other, according to various embodiments of the present disclosure.

FIG. 16D is a another perspective view of the wafer assemblies shown in FIG. 16C, with projection plates of the wafer assemblies exploded apart from the wafer assemblies, according to various embodiments of the present disclosure.

FIG. 16E is a perspective view of the projection plates of the wafer assemblies shown in FIG. 16D according to various embodiments of the present disclosure.

### DETAILED DESCRIPTION

The present disclosure relates to input/output (I/O) data connectors for reduced impedance and crosstalk. Due to increasing data transmission rates in modern computing environments, connector designs face significant challenges in maintaining signal integrity while minimizing crosstalk, impedance discontinuities, and ensuring mechanical robustness. Crosstalk between adjacent signal lines can lead to signal degradation and increased bit error rates, particularly as frequencies increase. Impedance dips or discontinuities along the signal path may cause reflections and signal distortions, further compromising data transmission quality. Additionally, connectors in high-usage environments such as data centers must maintain their structural integrity and electrical performance over numerous mating cycles.

Connector design often involves balancing multiple competing factors. Increasing shielding to reduce crosstalk may add bulk and cost to the connector. Tighter terminal spacing to achieve higher density may exacerbate crosstalk issues. Improving mechanical robustness through additional structural elements may impact electrical performance or increase manufacturing complexity. Designers carefully optimize these tradeoffs to create connectors that meet both electrical and mechanical requirements while remaining cost-effective and manufacturable.

According to various embodiments, a data connector may include a first wafer assembly and a second wafer assembly positioned in a housing. The first and second wafer assemblies may support rows of terminals and include locking projections that couple to form an interference connection. A conductive shield may be positioned at connection ends of the terminals, allowing for terminal deflection. The connector may also include rigid ground shields coupled to the rows of terminals.

In some cases, the conductive shields may cover portions of the terminal rows, with some portions left uncovered. The shields may be welded and/or crimped to the terminals. The connector may be a right-angle design with notched regions in the rigid ground shields to facilitate bending. The rigid ground shields may include integral channels to accommodate the terminals and can be secured to the wafer assemblies using injection molded rivets, where the rivets can be integral with bodies of the wafer assemblies.

The locking projections may form L-shaped or J-shaped hooks with geometries that ensure proper coupling. The connector may be designed for differential signaling, with terminals arranged in pairs sometimes in conjunction with ground terminals. Various shielding configurations, including flexible and rigid shields, may be employed to manage electromagnetic interference and maintain signal integrity. The connector thus includes multiple elements working in concert to achieve high-speed data transmission capabilities while maintaining mechanical reliability.

Embodiments of the connector described herein contribute to reduced crosstalk between signal lines by providing comprehensive shielding and controlled impedance environments for the signal paths. The combination of flexible and rigid shielding elements provide effective electromagnetic isolation and minimized impedance discontinuities while accommodating for mechanical requirements of the connector system. The interlocking wafer assemblies and shielding structures can enhance the ability to withstand multiple mating cycles without degradation of electrical or mechanical performance. This improved rigidity and durability is beneficial in high-usage environments where connectors are mated and unmated. Thus, a connector is described that balances electrical performance, mechanical robustness, and manufacturability, where the connector is well-suited for high-speed data transmission applications in demanding environments such as data centers and high-performance computing installations.

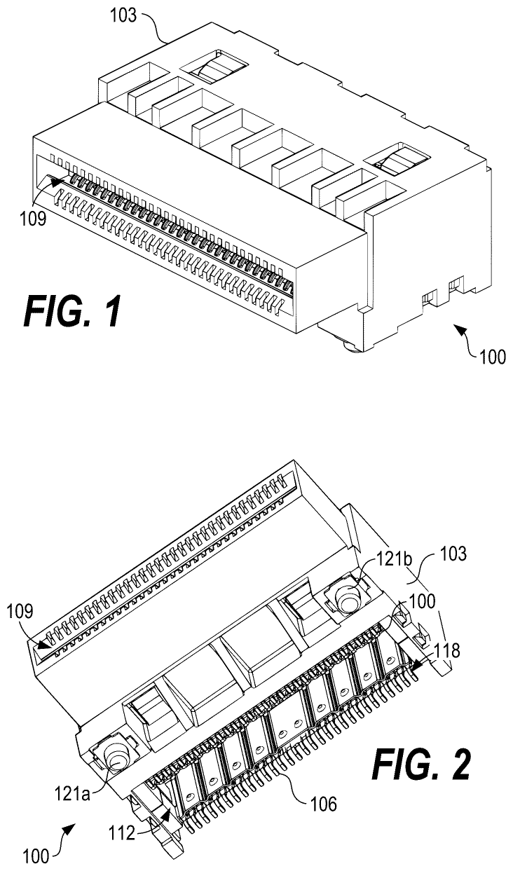

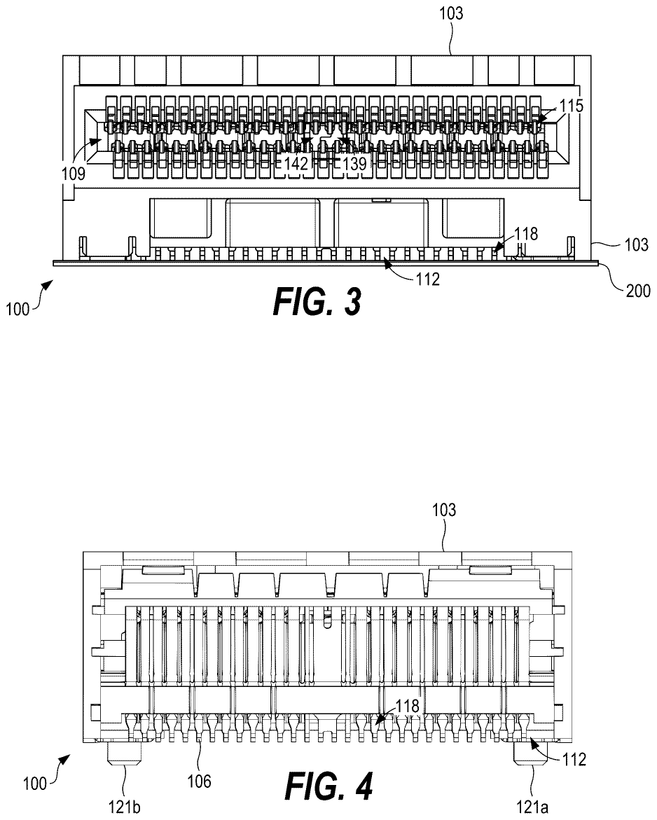

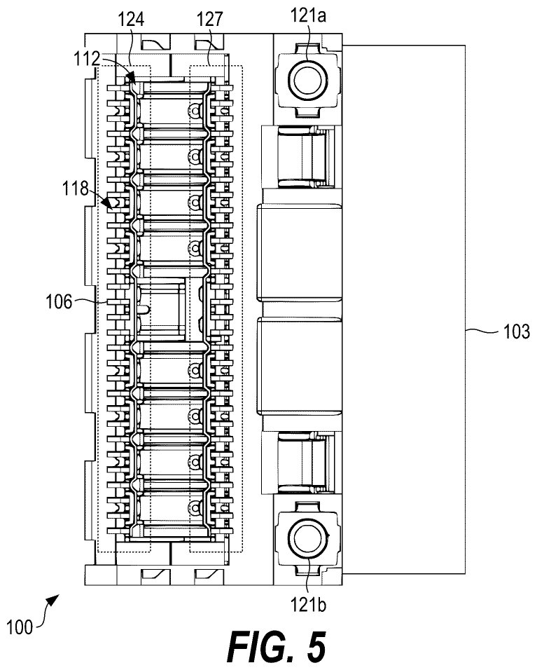

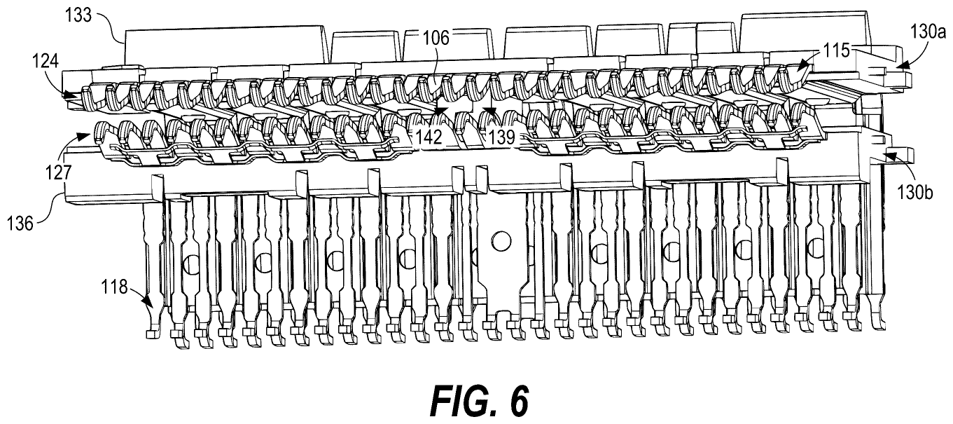

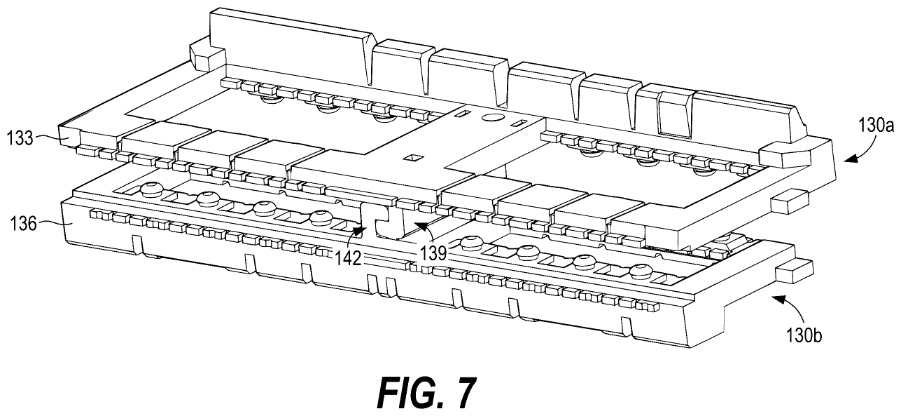

Turning now to the drawings, FIG. 1 is a top perspective view of a connector 100 (also referred to as an I/O connector, a data connector, and so forth) according to various embodiments of the present disclosure. FIG. 2 is a bottom perspective view of the connector 100, FIG. 3 is a front elevation view of the connector 100, and FIG. 4 is a rear elevation view of the connector 100 according to various embodiments of the present disclosure. FIG. 5 is a bottom view of the connector 100. The connector 100 is not drawn to any particular scale or size in the drawings. The shape, size, proportion, and other characteristics of the connector 100 can vary as compared to that shown. For example, the connector 100 can accommodate larger or smaller rows of terminal conductors (e.g., be wider or narrower), and other variations are within the scope of the examples described herein. A number of connectors similar to the connector 100 can be stacked or arranged side-by-side, for higher data rate interconnection systems. Additionally, one or more of the parts or components of the connector 100, as illustrated in the drawings and described herein, can be omitted in some cases. The connector 100 can also include other parts or components that are not illustrated.

Referring collectively to FIGS. 1-5, the connector 100 includes a housing 103 that supports a multitude of terminals 106 for data communication. The housing 103 may be formed from various materials, such as injection molded polymers, to provide structural support and protection for internal components including, but not limited to, the terminals 106. The housing 103 may be made from thermoplastics, thermosets, or other suitable materials that offer strength, durability, and manufacturability. It should be noted that the housing 103 and other components shown in the figures may not necessarily be to scale, as the drawings are intended to illustrate the principles and features of the connector 100 rather than exact dimensional relationships.

The terminals 106 can include conductive a subset of terminals arranged in terminal pairs for differential signaling, which can be provided alone or with one or more ground terminals. Various embodiments described herein show a right-angle connector. Thus, the housing 103 includes a front opening 109 and a bottom opening 112. The terminals 106 include connection ends 115 (also referred to as terminal tips) positioned in the front opening 109 and termination ends 118 (also referred to as terminal tails) positioned in the bottom opening 112. The terminals 106 may include a right-angle bend to orient with the body of the connector 100 in a right-angle orientation.

The connection ends 115 can be coupled to another connector (not shown) or port, and the termination ends 118 can be mounted on or otherwise coupled to a substrate 200, as shown in FIG. 3, although the disclosure is not limited to these particular connections. The substrate 200 can be embodied as a printed circuit board (PCB), and the termination ends 118 of the terminals 106 can be mounted and electrically coupled to contact pads on the PCB. In other cases, one or more of the termination ends 118 can be electrically coupled to conductors of cables, such as one or more twinax cables, for signal bypass applications. The housing 103 can include standoffs 121a, 121b (collectively “standoffs 121”) that can raise the housing 103 relative to the substrate 200 or act as locating features for orienting the connector 100 on the substrate 200.

In the embodiments shown in FIGS. 5-7, the terminals 106 of the connector 100 are arranged in rows. For instance, the connector 100 includes a first row of terminals 124 and a second row of terminals 127 each formed up of the terminals 106. It is understood, however, that other arrangements of terminals 106 can be employed, such as a single row of terminals 106, three or more rows of terminals 106, four or more rows of terminals 106, and so forth. The terminals 106 can be supported by and retained in one or more wafer assemblies. For instance, the connector 100 can include a first wafer assembly 130a supporting the first row of terminals 124 and a second wafer assembly 130b supporting the second row of terminals 127. While two wafer assemblies 130a, 130b are shown in various embodiments, it is understood that one or more wafer assemblies 130 can be provided.

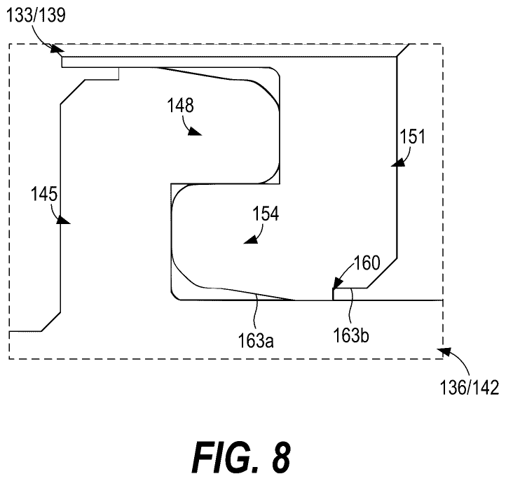

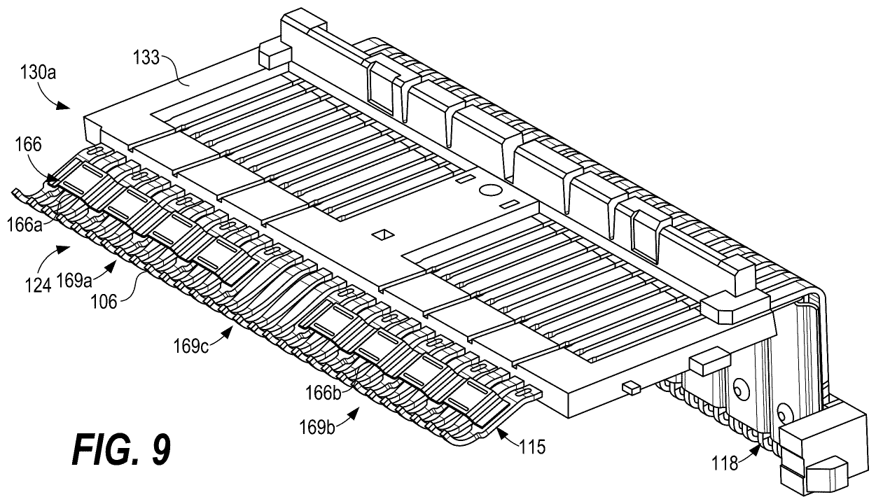

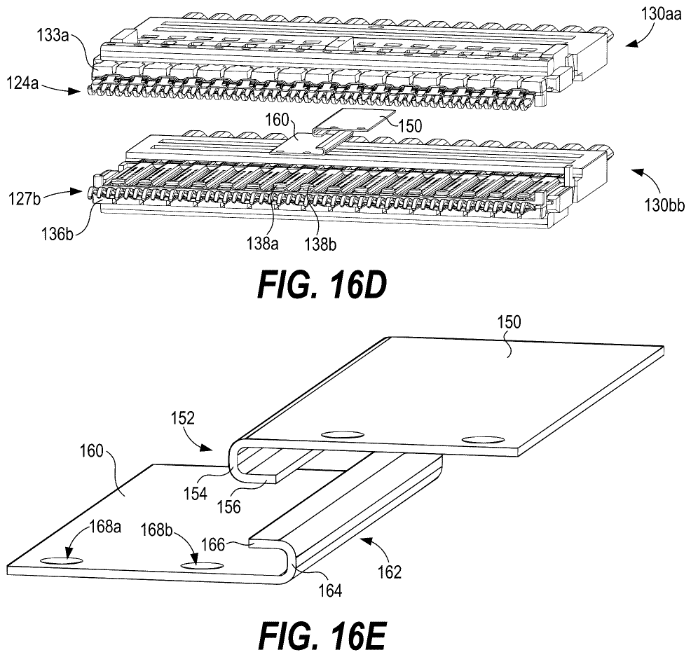

Moving along, FIG. 6 shows the first wafer assembly 130a and the second wafer assembly 130b of the connector 100 with the housing 103 and other components of the connector 100 omitted for explanatory purposes. While FIG. 6 shows the terminals 106 as situated in the first wafer assembly 130a and the second wafer assembly 130b, FIG. 7, on the other hand, shows the first wafer assembly 130a and the second wafer assembly 130b with the terminals 106 omitted for explanatory purposes. The wafer assemblies 130a and 130b are example wafer assemblies that can be positioned within the housing 103, and other types and styles of wafer assemblies can be relied upon. Other example wafer assemblies are depicted in FIGS. 16A-16D and described below Referring to FIGS. 6 and 7 collectively, the first wafer assembly 130a can be positioned in the housing 103 of the connector 100, and can include a first wafer body 133 supporting the first row of terminals 124. Similarly, the second wafer assembly 130b can be positioned in the housing 103 of the connector 100, and can include a second wafer body 136 supporting the second row of terminals 127. As the housing 103 of the connector 100 can include an opening on a rear face of the housing 103, as shown in FIG. 6, the first wafer body 133 and the second wafer body 136 can be slid or otherwise positioned into the housing 103.

Referring again to FIGS. 6 and 7, the first wafer body 133 and the second wafer body 136 (collectively “wafer bodies 133, 136”) can be formed from various materials to retain and provide structural support and electrical isolation for the terminals 106. In some aspects, the wafer bodies 133, 136 can be made from injection molded thermoplastics, such as polyetherimide (PEI), liquid crystal polymer (LCP), or polybutylene terephthalate (PBT), which offer dimensional stability, heat resistance, and electrical insulation. In other implementations, the wafer bodies 133, 136 may be fabricated using thermoset plastics or other engineered polymers that provide the desired mechanical and electrical characteristics. The choice of material for the wafer bodies 133, 136 can be based on various factors such as the intended operating environment, manufacturing processes, and specific electrical performance requirements of the connector 100.

The first wafer body 133 is shown as being positioned above the second wafer body 136 in FIGS. 6 and 7, and the wafer bodies 133, 136 can support a horizontal portion of the first row of terminals 124 and the second row of terminals 127 for terminal 106 having a right-angle bend. In various embodiments, the first wafer body 133 and the second wafer body 136 can be mechanically coupled to one another. To this end, the first wafer body 133 can include a first locking projection 139 that extends downward, whereas the second wafer body 136 can include a second locking projection 142 that extends upward to form a mechanical connection with the first locking projection 139. The first locking projection 139 and the second locking projection 142 are sized and positioned to couple to one another and form an interference connection in some embodiments. It is understood, however, that other types of connections can be employed, such as friction connections, locking connections, and so on.

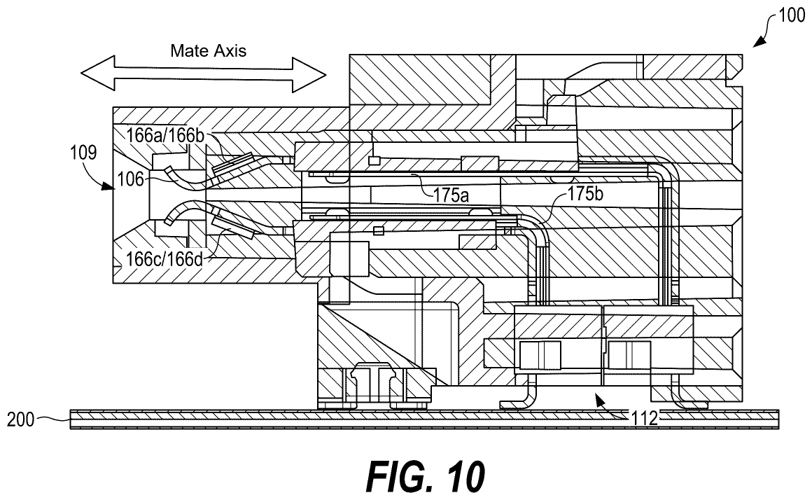

FIG. 8 shows an enlarged view of the first locking projection 139 and the second locking projection 142 as coupled to one another. The first locking projection 139 includes a vertical member 145 and a horizontal member 148 extending from the vertical member 145. Likewise, the second locking projection 142 includes a vertical member 151 and a horizontal member 154 extending from the vertical member 151. The vertical member 145 of the first wafer body 133 is offset horizontally from the vertical member 151 of the second wafer body 136. In other words, the vertical member 145 of the first wafer body 133 is closer to a first end of the wafer bodies 133, 136, whereas the vertical member 151 of the second wafer body 136 is positioned closer to a second, opposite end of the wafer bodies 133, 136.

Further, upper surfaces of the horizontal members 148, 154 can each include a step 160 that rises vertically and separates two planar surfaces 163a, 163b offset horizontally from one another. A first one of the two planar surfaces 163a, at the step 160, can slope downward from a rear end to a front end (e.g., a left-to-right slope shown in FIG. 8) of a respective one of the horizontal members 148, 154 to a flat or horizontal portion that extends to the step 160 such that the first planar surface 163a is offset vertically relative to the second planar surface 163b. The flat or horizontal portion of the first planar surface 163a can contact a surface of an opposite wafer body (or an opposite projection). For instance, the flat or horizontal portion of the first planar surface 163a of the first locking projection 139 can contact a top surface of the second wafer body 136, whereas the flat or horizontal portion of the planar surface 163a of the step 160 of the second locking projection 142 can contact a bottom surface of the first wafer body 133. The particular geometry of the first locking projection 139 and the second locking projection 142 can permit the first locking projection 139 and the second locking projection 142 to flex upon seating and engagement while providing a rigid connection between the first wafer body 133 and the second wafer body 136.

While being offset, in various embodiments, the vertical member 145 of the first wafer body 133 and the vertical member 151 of the second wafer body 136 can be positioned substantially in a center of the first wafer body 133 and the second wafer body 136, respectively, as shown in FIGS. 7 and 8. Moreover, the first locking projection 139 and the second locking projection 142 can be symmetrical, e.g., inverted and flipped horizontally relative to one another. In some embodiments, the first locking projection 139 and the second locking projection 142 each form an L-shaped or J-shaped hook or protrusion.

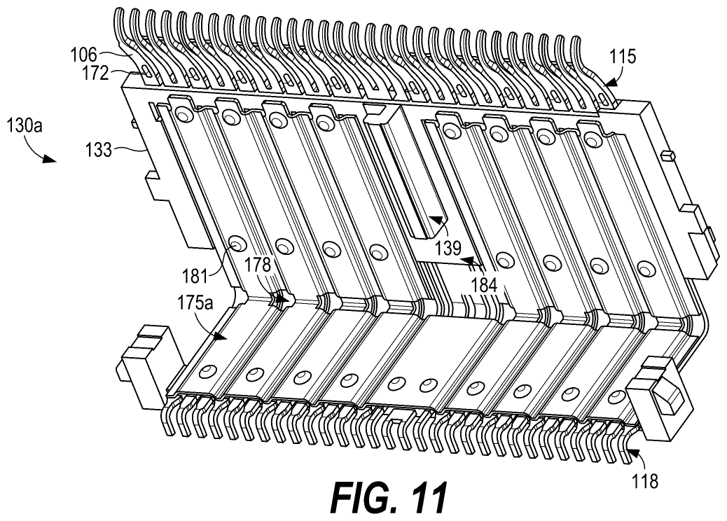

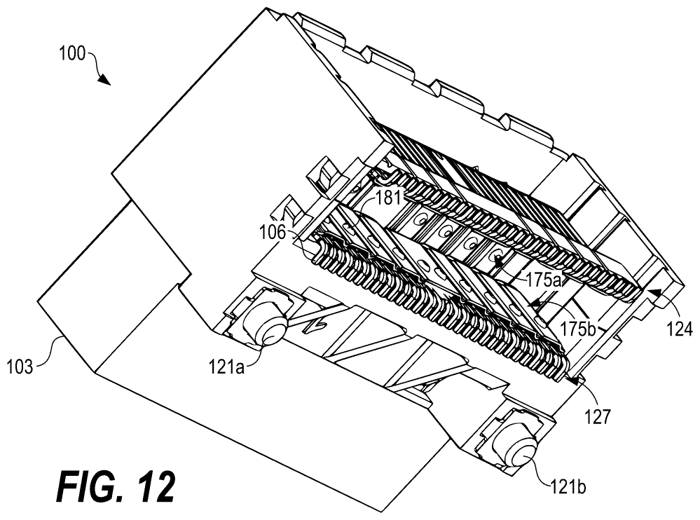

Generally, the coupling of the locking projections 139, 142 can be used to align and assemble the wafer assemblies 130 outside of the housing 103, which can help maintain good positional tolerance in the connector 100. Moreover, the locking projections 139, 142 provide rigidity and normal force to the terminals 106, helping termination ends of the terminals 106 tips establish reliable contact with conductive pads, terminals, etc. The coupling of the locking projections 139, 142 can prevent rotation of the wafer assemblies 130 relative to one another inside the housing 103 during operation. For instance, the locking projections 139, 142 can prevent rotation of the wafer assemblies 130 relative to one another inside the housing 103 upon insertion of a module card. Next, with reference to FIG. 9, a top perspective view of the first wafer assembly 130a is shown retaining the first row of terminals 124. FIG. 10 is a side cross-sectional view of the connector 100. Referring to FIGS. 9 and 10 collectively, in various embodiments, the connector 100 can include one or more shields, which can include one or more conductive shields 166a . . . 166d (collectively “conductive shields 166” or singularly “conductive shield 166”). The conductive shield 166 can be formed of a flexible metal material that permits the terminals 106 of the first row of terminals 124 (and the second row of terminals 127) to deflect, for instance, upon contact with an external connector (not shown), port, terminals, or a PCB inserted into the front port opening 109. The conductive shield 166, as positioned at a mating interface, can reduce impedance dips and reduce crosstalk in the connector 100.

The conductive shield 166 can be formed from various flexible conductive materials that allow for terminal deflection while providing electromagnetic shielding. In some aspects, the conductive shield 166 can be made from thin metal foils or sheets, such as copper, aluminum, or alloys thereof which offer electrical conductivity and mechanical flexibility suitable for shielding. For instance, in some embodiments, the conductive shield 166 can be formed of stainless steel including, but not limited to, SAE 304 stainless steel. In other implementations, the conductive shield 166 can utilize conductive fabrics or meshes, which can provide both flexibility and shielding. These materials may incorporate metal fibers or coatings on a flexible substrate, and can be selectively plated with conductive material in some examples. In other embodiments, the conductive shield 166 can be formed up of conductive polymers or polymer composites that contain conductive particles or fibers, allowing for moldability and flexibility while maintaining shielding properties.

The conductive shield 166 can include a single piece of material welded, crimped, or otherwise positioned towards connection ends of at least one of the first row of terminals 124 (and the second row of terminals 127). In some embodiments, the connector 100 includes a first conductive shield 166a covering a first portion 169a of the first row of terminals 124 and a second conductive shield 166b covering a second portion 169b of the first row of terminals 124. Further, in some embodiments, a third portion 169c of the first row of terminals 124 is not covered by the first conductive shield 166a or the second conductive shield 166b, leaving some terminals 106 in the first row of terminals 124 non-shielded or uncovered.

While not shown in FIG. 9, it is understood that the connector 100 can include further conductive shielding to cover all or portions of the second row of terminals 127. To this end, the connector 100 can include a third conductive shield 166c covering a first portion of the second row of terminals 127, and a fourth conductive shield 166d covering a second portion of the second row of terminals 127. A third portion of the second row of terminals 127 is not covered by the third conductive shield 166c or the fourth conductive shield 166d, leaving some terminals 106 in the second row of terminals 127 non-shielded or uncovered.

While four conductive shields 166a . . . 166d are shown in various embodiments of the disclosure, it is understood that, in some implementations, a first conductive shield can be positioned on the first row of terminals 124 and a second conductive shield can be positioned on the second row of terminals 127, having a particular geometry that covers and does not cover the aforementioned portions of the terminals 106 as described above.

In some embodiments, the conductive shields 166 can be welded (e.g., using ultrasonic welding, infrared (IR) welding, and so forth) to respective terminals 106 in the first row of terminals 124 and the second row of terminals 127. In addition to or in lieu of welding, the first row of terminals 124 and/or the second row of terminals 127 can each include terminals 106 having a terminal aperture 172 (or aperture 172) positioned therein. As such, ends of the conductive shields 166 can be crimped, bent, or otherwise positioned through a respective terminal aperture 172 of the first row of terminals 124 and/or the second row of terminals 127. In some embodiments, the terminals 106 having the terminal aperture 172 are ground terminals, which can facilitate commoning or grounding of the terminals 106. As shown in FIG. 9, terminal apertures 172 are positioned on the most proximal and distal terminals 106, while other terminal apertures 172 are positioned in terminals 106 between the most proximal and distal terminals 106. Thus, crimps can occur in multiple locations along an elongated body of the conductive shields 166 as well as at ends of the conductive shields 166.

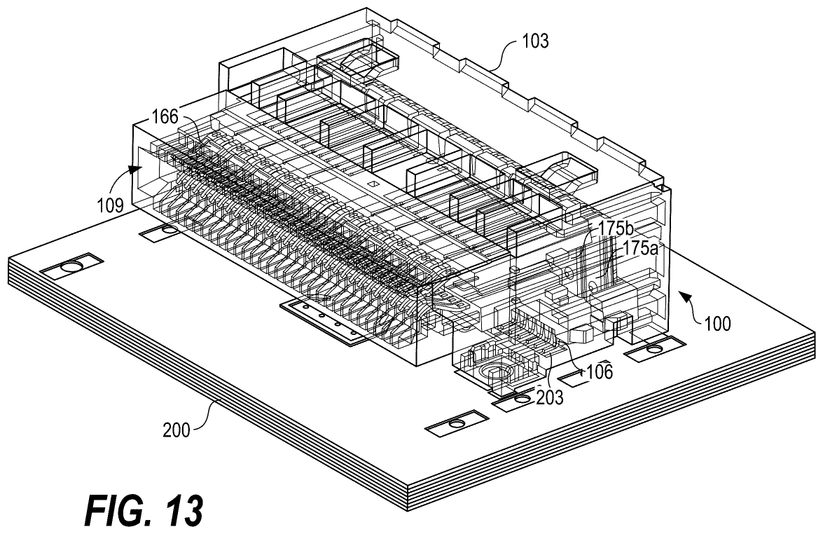

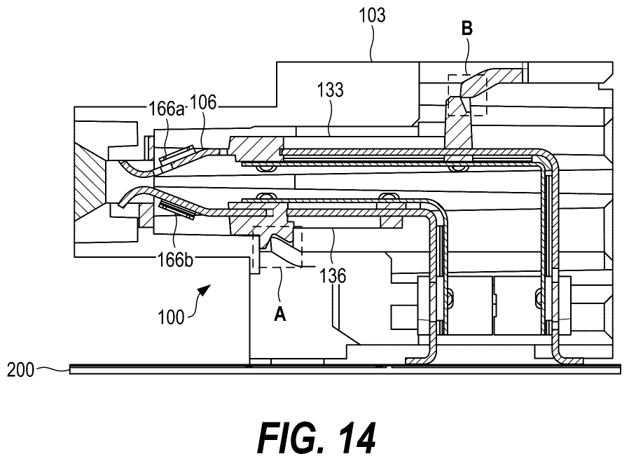

Moving along, FIG. 11 shows a bottom perspective view of the first wafer assembly 130a and FIG. 12 shows a bottom perspective view of the connector 100. Referring collectively to FIGS. 10, 11, and 12, the connector 100 can include at least one of a first ground shield 175a and a second ground shield 175b (collectively “ground shields 175”). The ground shields 175 can be formed from various conductive rigid materials to provide effective electromagnetic shielding and structural support. In some embodiments, the ground shields 175 can be made from metals such as copper, aluminum, brass, or stainless steel, which offer electrical conductivity and mechanical strength. In other implementations, the ground shields 175 can utilize metal alloys or composites that combine high conductivity with enhanced corrosion resistance or thermal management properties. Some embodiments can employ plated or coated materials, where a base metal is covered with a layer of highly conductive material to optimize shielding performance while maintaining desired mechanical characteristics. In some embodiments, the ground shields 175 can be fabricated from conductive plastics or polymer composites infused with metallic particles or fibers, providing a balance of rigidity, weight reduction, and electromagnetic shielding capabilities.

In embodiments in which the connector 100 includes two terminal rows, the first ground shield 175a can positioned below and coupled to the first row of terminals 124. In some embodiments, the first ground shield 175a can extend substantially along a length of the first row of terminals 124 and the terminals 106 thereof, for instance, from the connection ends 115 to the termination ends 118. The second ground shield 175b can positioned above and coupled to the second row of terminals 127. In some embodiments, the second ground shield 175b can extend substantially along a length of the second row of terminals 127 and the terminals 106 thereof, similarly, from the connection ends 115 to the termination ends 118.

In embodiments in which the connector 100 is a right-angle connector, the first ground shield 175a and the second ground shield 175b can each include notched-out regions 178 that facilitate a right-angle bend made in the first ground shield 175a and the second ground shield 175b. In some implementations, at least one of the first ground shield 175a and the second ground shield 175b can be formed from a single lead frame. The lead frame can include a flat sheet of conductive material, such as copper or a copper alloy, that is stamped or etched to create a desired shield shape and features. To this end, the notched-out regions 178 can be cut or removed from the lead frame during the formation process, creating areas of reduced material that facilitate bending of the ground shields 175.

Moreover, a lead frame can be further processed to form channels that can accommodate the terminals 106. This may be accomplished by pinching or folding portions of the lead frame to create raised walls or dividers between adjacent terminal positions. The pinching process can involve bending the material upward or downward at specific intervals along the length of the lead frame, resulting in a series of parallel channels and forming a U-shaped shield. Pairs of terminals 106, also referred to as terminal pairs, for differential signaling can be positioned above or within these channels, with the raised walls of the channels providing isolation between adjacent pairs. The channels can help maintain consistent spacing and impedance characteristics for the terminal pairs throughout the length of the ground shield 175.

After terminals 106 are positioned within the channels, the lead frame may undergo a bending operation to form the right-angle configuration. The notched-out regions 178 may allow the lead frame to bend more easily at predetermined points, facilitating the formation of a smooth right-angle bend without compromising the structural integrity of the ground shield 175 or the positioning of the terminals. The resulting structure may include a ground shield 175 having a right-angle bend that extends from a mating interface of the connector 100 to a mounting interface, providing continuous shielding and ground reference for the terminals 106 throughout their entire path.

As the channels of the ground shield 175 can be formed through bending, all of the components of the ground shield 175 can be integral with one another. Thus, the channels of the ground shield 175 can be formed integral with one another, where the first ground shield 175a and the second ground shield 175b are each formed from a single piece of conductive material such that terminals 106 of the first row of terminals 124 and the second row of terminals 127 being situated in the channels.

The ground shields 175 can be positioned on and coupled to a respective wafer body 133, 136. For instance, the ground shields 175 can be coupled to a respective wafer body 133, 136 using staking caps or rivets 181, which can be metallic or injection molded polymer in some embodiments. The rivets 181 can be formed during a formation of the wafer bodies 133, 136 in some embodiments (e.g., during a single injection molding process) and thus, the rivets 181 can be integral with the wafer bodies 133, 136. The rivets 181 can thus be situated periodically along each channel, for example, for structural rigidity. In some embodiments, the first ground shield 175a includes a first gap 184 positioned between two portions of the first ground shield 175a. The first locking projection 139 can be positioned or otherwise situated in the first gap 184. Similarly, the second ground shield 175b can include a second gap positioned between two portions of the second ground shield 175b, where the second locking projection 142 is positioned in a second gap (not shown) in a same or similar arrangement as the first gap 184 and the first locking projection 139.

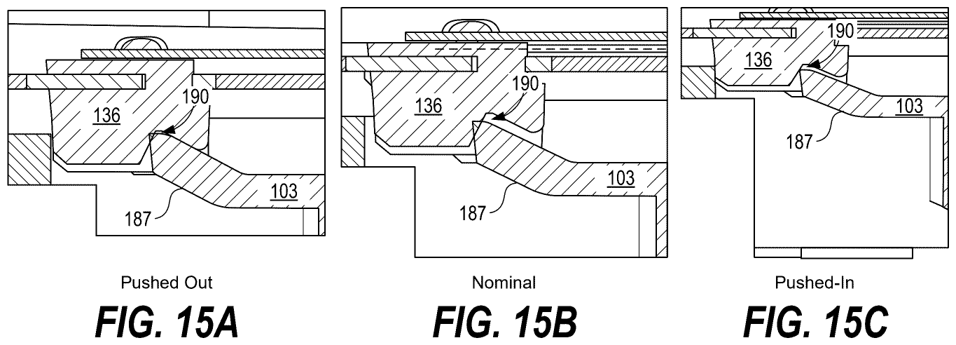

FIG. 13 shows a partially transparent view of the connector 100 as situated on a substrate 200. The terminals 106 have a right-angle bend in a body portion that is situated between the connection ends 115 and the termination ends 118. The right-angle configuration of the terminals 106 allows the connector 100 to transition from a horizontal mating interface to a vertical mounting interface, which can be advantageous in certain applications where space constraints or board layout considerations necessitate such an arrangement. The termination ends 118 of the terminals 106 can be seen making contact with the substrate 200, which can include a printed circuit board or other suitable mounting surface.

The one or more conductive shields 166 are shown covering the connection ends 115 of the terminals 106, providing electromagnetic shielding at the mating interface of the connector 100. The flexible shielding allows for some degree of terminal deflection during mating while maintaining effective shielding properties. Additionally, the ground shields 175 are shown extending along the length of the terminals 106 in their respective rows. The ground shields 175 can provide continuous grounding and shielding from the mating interface to the mounting interface, following the right-angle bend of the terminals 106. The combination of the flexible conductive shield 166 at the connection ends 115 and the ground shield 175 along the length of the terminals contribute to improved signal integrity and reduced electromagnetic interference in high-speed data transmission applications. The mounting interface includes the terminals 106 positioned on conductive pads 203 situated on the substrate 200, although other connections can be employed.

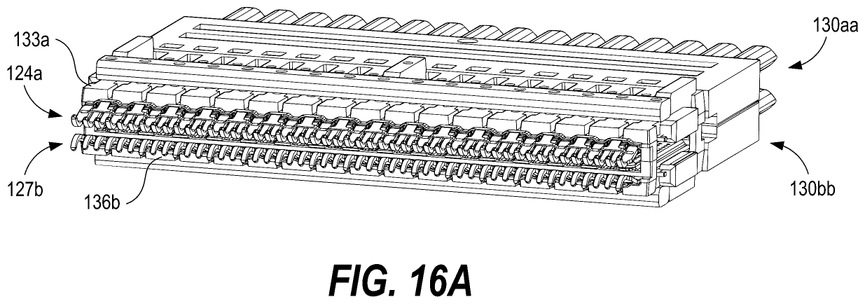

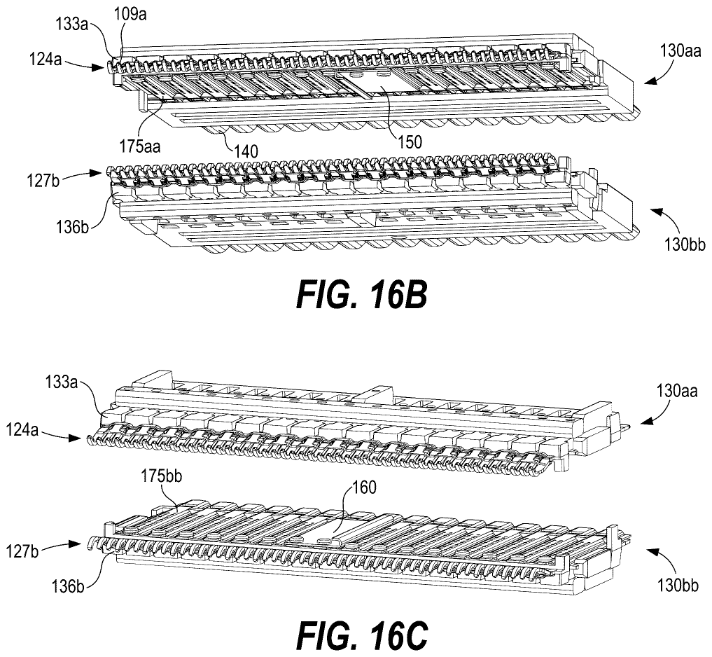

FIG. 14 illustrates a cross-sectional view of the connector 100 mounted on a substrate 200, showing the terminals 106 as retained and positioned within the housing 103 of the connector 100. Region A and Region B show an interface between representative wafer body 136 and the housing 103 of the connector, where the wafer bodies 136 may be pushed or datumed against an inner surface of the housing 103 during formation of the connector 100 such that optimal positional tolerances are maintained for connection of the terminals 106 to those of an external connector and an overall desired performance of the connector 100 is provided. FIGS. 15A-15C are enlarged views of Region A showing a “pushed out” position between the wafer body 136 and the housing 103, as well as a “nominal” position and a “pushed-in” position. The housing 103 can include a projection having an angled surface 187 configured to be positioned in a receptacle 190 of the wafer body 136, which creates an interference connection between the wafer body 136 and the housing 103. Such positioning may be ideal for ensuring proper connection of the terminals 106 and performance of the connector 100.

For instance, the wafer bodies 133, 136 may latch to the housing 103. In some implementations, latching can include providing a back-angled surface on the wafer bodies 133, 136 that interface with corresponding features on the housing 103. These surfaces may help achieve and maintain the desired positional tolerances for the terminals 106. Additionally, FIG. 14 shows the first conductive shield 166a and the second conductive shield 166c positioned near the mating interface of the connector 100, which may provide electromagnetic shielding for the terminal connection ends 115.

While various embodiments described herein illustrate a right-angle connector configuration, the connector 100 may be implemented in other orientations. In some embodiments, the connector 100 may be a straight connector, where the connection ends 115 and termination ends 118 of the terminals 106 are aligned along the same axis. Alternatively, the connector 100 may be configured with a different angle between the mating interface and the mounting interface, such as a 45-degree angle or any other suitable angle. The flexibility in connector orientation may allow for adaptation to various spatial constraints and circuit board layouts. In some implementations, the ground shields 175 and conductive shields 166 may be modified to accommodate different connector geometries while maintaining their shielding effectiveness. The wafer assemblies 130a, 130b and associated components may also be designed to support alternative connector configurations, providing versatility in connector design and application.

FIG. 16A is a perspective view of another example first wafer assembly 130aa and another example second wafer assembly 130bb according to other embodiments. FIG. 16B is a first perspective view of the first and second wafer assemblies 130aa and 130bb shown in FIG. 16A, exploded apart from each other. FIG. 16C is a second perspective view of the first and second wafer assemblies 130aa and 130bb shown in FIG. 16A, exploded apart from each other. The wafer assemblies 130aa and 130bb can be positioned within the housing 103 of the connector 100 or within similar housings of other connectors. The wafer assemblies 130aa and 130bb are similar to the wafer assemblies 130a and 130b shown in FIG. 6 but can be wider and do not include or rely upon a right-angle bend in the rows of terminals. The wafer assemblies 130aa and 130bb also include different types of locking projections, particularly locking projections formed from conductive projection plates, as described below.

Referring among FIGS. 16A-16C, the first wafer assembly 130aa includes a first wafer body 133a supporting a first row of terminals 124a, a first ground shield 175aa, and a first projection plate 150, among possibly other components. The second wafer assembly 130bb includes a second wafer body 136b supporting a second row of terminals 127b, a second ground shield 175bb, and a second projection plate 160, among possibly other components. The terminal ends of each terminal in the rows of terminals 124a and 127b are electrically coupled to conductors in cables in the example shown in FIGS. 16A-16C, for signal bypass applications. For example, the terminal end of the terminal 109A, as shown in FIG. 16B, is electrically coupled to a conductor in the cable 140, and other terminal ends of other terminals in the rows of terminals 124a and 127b are also electrically coupled to other conductors in other cables. In other examples, the rows of terminals 124a and 127b can be formed to have right-angle bends for electrical connections to a PCB, similar to the embodiments described above.

The first projection plate 150 and the second projection plate 160 include locking projections, as described in further detail below with reference to FIG. 16E. The locking projections of the projection plates 150 and 160 are similar in form and function to the locking projections 139 and 142 shown in FIG. 7 but are not integrally formed as parts of the wafer bodies 133a and 133b. Instead, the projection plates 150 and 160 are separate pieces and can be formed from a conductive material, such as a sheet of conductive metal material.

As shown in FIG. 16B, the first projection plate 150 is positioned against and contacts a surface of the first ground shield 175aa. The first projection plate 150 is electrically coupled with the first ground shield 175aa based on contact and, in some cases, can be soldered, welded, or otherwise secured and electrically to the first ground shield 175aa. As shown in FIG. 16C, the second projection plate 160 is positioned against and contacts a surface of the second ground shield 175bb. The second projection plate 160 is electrically coupled with the second ground shield 175bb based on contact and, in some cases, can be soldered, welded, or otherwise secured and electrically to the second ground shield 175bb. The projection plates 150 and 160 can also be secured in place in the wafer assemblies 130aa and 130bb, respectively, by the use of staking caps or rivets, as described in further detail below.

FIG. 16D is a another perspective view of the wafer assemblies 130aa and 130bb, with the first and second projection plates 150 and 160 exploded apart from the wafer assemblies 130aa and 130bb. FIG. 16E is a perspective view of the projection plates 150 and 160. As shown in FIG. 16E, the first projection plate 150 includes a first locking projection 152 formed along one edge of the first projection plate 150, and the second projection plate 160 includes a second locking projection 162 formed along one edge of the second projection plate 160. The first and second projection plates 150 and 160 can be formed to have the same shape and size but are inverted and flipped relative to one another.

The first locking projection 152 and the second locking projection 162 each form an L-shaped or J-shaped hook, protrusion, or projection. The first locking projection 152 includes a vertical member 154 and a horizontal member 156 extending from the vertical member 154. The second locking projection 162 includes a vertical member 164 and a horizontal member 166 extending from the vertical member 164. The vertical member 154 of the first projection plate 150 is offset horizontally from the vertical member 164 of the first projection plate 160 when the wafer assemblies 130aa and 130bb are assembled together. Thus, the locking projections 152 and 162 can hook and mate with each other in a type of interference connection, similar to the way that the locking projections shown in FIG. 8 are hooked and mated to each other. When hooked and mated together, the horizontal member 154 of the first locking projection 152 will mechanically and electrically contact with the horizontal member 164 of the second locking projection 162.

The hooking and mating of the locking projections 152 and 162 can align the wafer assemblies 130aa and 130bb with respect to each other, which can help maintain good positional tolerance in the connector 100. The locking projections 152 and 162 can also help to secure and align the first row of terminals 124a with respect to the second row of terminals 127b and prevent rotation of the wafer assemblies 130aa and 130bb relative to one another, among other benefits. Because the locking projections 152 and 162 are formed of a conductive metal material, the locking projections 152 and 162 can be electrically coupled with each other when the locking projections 152 and 162 are hooked and mated with each other. Thus, the locking projections 152 and 162 can also provide an electrical coupling and common between the ground shields 175aa and 175bb of the wafer assemblies 130aa and 130bb in a central location of the connector 100.

The projection plates 150 and 160 can be secured in place in the wafer assemblies 130aa and 130bb, respectively, by the use of staking caps or rivets. For example, as shown in FIG. 16E, the projection plate 160 includes apertures 168a and 168b, and the projection plate 150 includes similar apertures. When the wafer assembly 130bb is assembled, the plastic or polymer material of the second wafer body 136b can be molded to extend through apertures in the second ground shield 175bb and through the apertures 168a and 168b in the projection plate 160. The molded material can then be formed into the staking caps or rivets 138a and 138b, among other staking caps or rivets of the wafer assembly 130bb, in a heat staking process. Thus, the staking caps or rivets 138a and 138b can help to secure the second projection plate 160 in place against the second ground shield 175bb. The second projection plate 160 can also be electrically coupled with the second ground shield 175bb by soldering, welding, or other process steps, before the second wafer body 136b is molded.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A connector, comprising:
a first wafer assembly positioned in a housing of the connector, the first wafer assembly comprising a first wafer body supporting a first row of terminals, the first wafer body comprising a first locking projection extending downward;
a second wafer assembly positioned in the housing of the connector, the second wafer assembly comprising a second wafer body supporting a second row of terminals, the second wafer body comprising a second locking projection extending upward, wherein the first locking projection and the second locking projection are sized and positioned to couple to one another and form an interference connection; and
a conductive shield positioned towards connection ends of at least one of the first row of terminals and the second row of terminals, the conductive shield being formed of a flexible material that permits terminal deflection.

2. The connector according to claim 1, wherein:
the conductive shield is a first conductive shield covering a first portion of the first row of terminals;
the connector further comprises a second conductive shield covering a second portion of the first row of terminals; and
a third portion of the first row of terminals is not covered by the first conductive shield or the second conductive shield.

3. The connector according to claim 2, wherein:
the connector further comprises a third conductive shield covering a first portion of the second row of terminals;
the connector further comprises a fourth conductive shield covering a second portion of the second row of terminals; and
a third portion of the second row of terminals is not covered by the third conductive shield or the fourth conductive shield.

4. The connector according to claim 3, wherein:
the first conductive shield and the second conductive shield are welded to a number of terminals among the first row of terminals; and
the third conductive shield and the fourth conductive shield are welded to a number of terminals among the second row of terminals.

5. The connector according to claim 3, wherein:
the first row of terminals and the second row of terminals each comprise terminals having an aperture positioned therein, wherein ends of the first, second, third, and fourth conductive shields are crimped through a respective terminal aperture of the first row of terminals and the second row of terminals.

6. The connector according to claim 5, wherein the terminals having the aperture positioned therein are ground terminals.

7. The connector according to claim 1, further comprising a first rigid ground shield positioned below and coupled to the first row of terminals, the first rigid ground shield extending substantially along a length of the first row of terminals.

8. The connector according to claim 7, further comprising a second rigid ground shield positioned above and coupled to the second row of terminals, the second rigid ground shield extending substantially along a length of the second row of terminals.

9. The connector according to claim 8, wherein the connector is a right-angle connector, and the first rigid ground shield and the second rigid ground shield each comprise a plurality of notched-out regions that facilitate a right-angle bend of the first rigid ground shield and of the second rigid ground shield.

10. The connector according to claim 8, wherein the first rigid ground shield and the second rigid ground shield each comprise a plurality of channels formed integral with one another, the first rigid ground shield and the second rigid ground shield each being formed from a single piece of conductive material, a subset of terminals of the first row of terminals and the second row of terminals being situated in the plurality of channels.

11. The connector according to claim 8, wherein:
the first rigid ground shield comprises a first gap positioned between two portions of the first rigid ground shield;
the first locking projection is positioned in the first gap;
the second rigid ground shield comprises a second gap positioned between two portions of the second rigid ground shield; and
the second locking projection is positioned in the second gap.

12. The connector according to claim 1, wherein the connector is a right-angle connector, the first row of terminals having a first right-angle bend, and the second row of terminals having a second right-angle bend, the connection ends of the first row of terminals and the second row of terminals being positioned in a front opening of a body of the connector, and mounting ends of the first row of terminals and the second row of terminals being positioned in a bottom opening of the body of the connector for coupling to a substrate.

13. The connector according to claim 1, wherein the first locking projection and the second locking project each comprise vertical members offset from one another and horizontal members extending from the vertical members, each forming an L-shaped or J-shaped hook.

14. The connector according to claim 13, wherein upper surfaces of the horizontal members comprise a step that separates two planar surfaces offset from one another, a first one of the two surfaces sloping downward from a rear end to a front end of a respective horizontal member, the upper surfaces of the horizontal members contacting a surface of an opposite wafer body.

15. The connector according to claim 1, wherein the first locking projection and the second locking projection hook are offset from one another and each positioned approximately in a middle of the connector, and the first locking projection comprises a first L-shaped or J-shaped hook projection and the second locking projection comprises a second L-shaped or J-shaped hook projection.

16. A connector, comprising:
a first wafer assembly comprising a first wafer body, a first row of terminals, and a first locking projection extending downward; and
a second wafer assembly comprising a second wafer body, a second row of terminals, and a second locking projection extending upward,
wherein the first locking projection and the second locking projection are sized and positioned to couple to one another and form an interference connection.

17. The connector according to claim 16, wherein:
the first locking projection is formed along an edge of a first projection plate;
the second locking projection is formed along an edge of a second projection plate; and
the first projection plate is formed of a conductive material and the second projection plate is formed of a conductive metal material.

18. The connector according to claim 17, wherein:
the first wafer assembly further comprises a first ground shield;
the first projection plate is electrically coupled to the first ground shield;
the second wafer assembly further comprises a second ground shield; and
the second projection plate is electrically coupled to the second ground shield.

19. The connector according to claim 16, wherein:
the first locking projection comprises a first L-shaped or J-shaped hook projection; and
the second locking projection comprises a second L-shaped or J-shaped hook projection.

20. The connector according to claim 19, wherein the first L-shaped or J-shaped hook projection is electrically coupled with the second L-shaped or J-shaped hook projection.
